(19) United States
(12) Patent Application Publication
(10) Pub. No.: US 2025/0005643 A1
(43) Pub. Date: Jan. 2, 2025

(54) SYSTEMS AND METHODS FOR GENERATING RECOMMENDATIONS FOR A VEHICLE, AND VEHICLES

(71) Applicant: Toyota Motor Credit Corporation, Plano, TX (US)

(72) Inventors: Michael Reid, Prosper, TX (US); Joshua Batie, Frisco, TX (US); Imad Zahid, Carrollton, TX (US)

(73) Assignee: Toyota Motor Credit Corporation, Plano, TX (US)

(21) Appl. No.: 18/216,066

(22) Filed: Jun. 29, 2023

(51) Int. Cl. G06Q 30/0601; G07C 5/08

(52) U.S. Cl. CPC G06Q 30/0631; G07C 5/08

(57) ABSTRACT

A system for recommendations with respect to a vehicle includes network interface hardware communicatively coupled to one or more processors, and one or more memory modules to store machine-readable instructions communicatively coupled to the processors. The system receives vehicle data related to one or more of vehicle performance data, vehicle occupant data, or vehicle owner data. At least a portion of the vehicle data is generated by one or more vehicle sensors mounted to the vehicle. The one or more processors generates a first listing of a plurality of recommendations. The system determines current accessories or services on the vehicle and the first listing of the plurality of recommendations is modified to provide a tailored listing based on the determination. The system generates a communication including one or more recommendations from the tailored listing and sends the communication to a user interface device associated with the vehicle.

### TECHNICAL FIELD

The present specification generally relates to systems and methods for generating recommendations and vehicles and, more specifically, methods and systems for collecting data regarding vehicles and providing targeted recommendations for vehicle accessories, software, and services.

### BACKGROUND

There are many different after-market accessories, including software packages and services available to modify vehicles to fit users' specific needs or desires. These after-market accessories may enhance vehicle performance, improve safety, enhance comfort and convenience, protect the vehicle, support outdoor activities, and/or personalize the vehicle to reflect the user's personality and style. Users may not have knowledge of the accessories available for the vehicle or whether particular accessories are applicable to their vehicle. Additionally, the sellers of vehicle accessories may not be aware of accessories already implemented on a vehicle, or the accessories most suitable for the needs of the particular user.

Accordingly, a need exists for alternative systems, methods, and vehicles for providing recommendations for vehicle accessories to vehicle owners and operators that are based more particularly on the user's needs.

### SUMMARY

In one embodiment, a system for generating recommendations with respect to a vehicle includes one or more processors, network interface hardware, and one or more memory modules. The network interface hardware is communicatively coupled to the one or more processors. The one or more memory modules are communicatively coupled to the one or more processors and store machine-readable instructions. When the machine-readable instructions are executed by the one or more processors, the system is caused to: receive vehicle data related to one or more of vehicle performance data, vehicle occupant data, or vehicle owner data, wherein the at least a portion of the data is generated by one or more vehicle sensors mounted to the vehicle; generate a first listing of a plurality of recommendations based on the vehicle data; determine with the one or more vehicle sensors, current accessories mounted to vehicle or current services performed on the vehicle; modify the first listing of the plurality of recommendations to provide a tailored listing of the plurality of recommendations based on the determination of current accessories mounted to the vehicle or current services performed on the vehicle; generate a communication with the one or more processors including one or more recommendations from the tailored listing of the plurality of recommendations; and send the communication to a user interface device associated with the vehicle.

In another embodiment, a method of determining recommendations with respect to a vehicle includes: receiving vehicle data related to one or more of vehicle performance data, vehicle occupant data, or vehicle owner data, wherein at least a portion of the data is generated by one or more vehicle sensors mounted to the vehicle; generating with a processor communicatively coupled to the one or more vehicle sensors a first listing of a plurality of recommendations based on the vehicle data; determining with the one or more vehicle sensors, current accessories mounted to vehicle or current services performed on the vehicle; modifying the first listing of the plurality of recommendations to provide a tailored listing of the plurality of recommendations based on a determination of current accessories mounted to the vehicle or current services performed on the vehicle; generating a communication with the one or more processors including one or more recommendations from the tailored listing of the plurality of recommendations; and sending the communication to a user interface device associated with the vehicle.

In yet another embodiment, a vehicle includes one or more processors, one or more vehicle sensors, one or more user interface devices, network interface hardware, and one or more memory modules. The one or more vehicle sensors are mounted to the vehicle. The one or more user interface devices are communicatively coupled to the one or more processors. The network interface hardware is communicatively coupled to the one or more processors. The one or more memory modules are communicatively coupled to the one or more processors and store machine-readable instructions. When the machine-readable instructions are executed by the one or more processors, the vehicle is caused to: communicate vehicle data related to one or more of vehicle performance data, vehicle occupant data, or vehicle owner data to a remote server, wherein at least a portion of the data is generated by the one or more vehicle sensors mounted to the vehicle; determine with the one or more vehicle sensors, current accessories mounted to vehicle or current services performed on the vehicle; communicate the current accessories mounted to vehicle or current services performed on the vehicle to the remove server; receive a communication with a recommendation from a tailored listing of a plurality of recommendations based a plurality of recommendations based on the vehicle data and the determination of current accessories mounted to the vehicle or current services performed on the vehicle from the remote server; and display the communication to a user interface device associated with the vehicle; receive a user input from the user interface device selecting a recommendation from the tailored listing of the plurality of recommendations; and automatically update vehicle software based on the user input.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts components of a system for generating recommendations with respect to a vehicle, according to one or more embodiments shown and described herein;

FIG. 2 depicts a flowchart of an example method for a providing a recommendation to a user device, according to one or more embodiments shown and described herein;

FIG. 3 depicts a flowchart of an example method for a providing a recommendation for a software accessory, according to one or more embodiments shown and described herein;

FIG. 4 depicts a flowchart of an example method for the modification and ranking of a list of recommendations, according to one or more embodiments shown and described herein; and

FIG. 5 depicts an example of a user interface device for communicating a list of recommendations, according to one or more embodiments shown and described herein.

### DETAILED DESCRIPTION

Embodiments of the present disclosure are directed to systems, methods, and vehicles for generating and providing recommendations for vehicle accessories (e.g., physical accessories, software updates, services, financial options, etc.) through a vehicle head unit or a user device, for example. In embodiments, a system may receive vehicle data related to one or more of vehicle performance data, vehicle occupant data, or vehicle owner data. In embodiments, at least a portion of the data is generated by one or more vehicle sensors mounted to the vehicle. The system may generate a first listing of a plurality of recommendations based on the data. The system may further determine with the one or more vehicle sensors, current accessories mounted to the vehicle or current services performed on the vehicle and modify the first listing of the plurality of recommendations to provide a tailored listing of the plurality of recommendations based on a determination of current accessories mounted to the vehicle or current services performed on the vehicle. Based on the listing, the system may further generate a communication including the tailored listing of the plurality of recommendations and send the user the communication including one or more recommendations from the tailored listing to the user. That is, the vehicle may provide improved display of recommendations to a user by tailoring the listing of available accessories based on data collected by one or more vehicle sensors. Moreover, such tailoring of recommendation lists may provide reduced network communication traffic and bandwidth by providing more targeted or focused recommendations as opposed to larger general listings of available accessories. Moreover, as recommendations may be more targeted to a user's specific needs local processing power or memory needs may be reduced. These and additional benefits and features will be discussed in greater detail below.

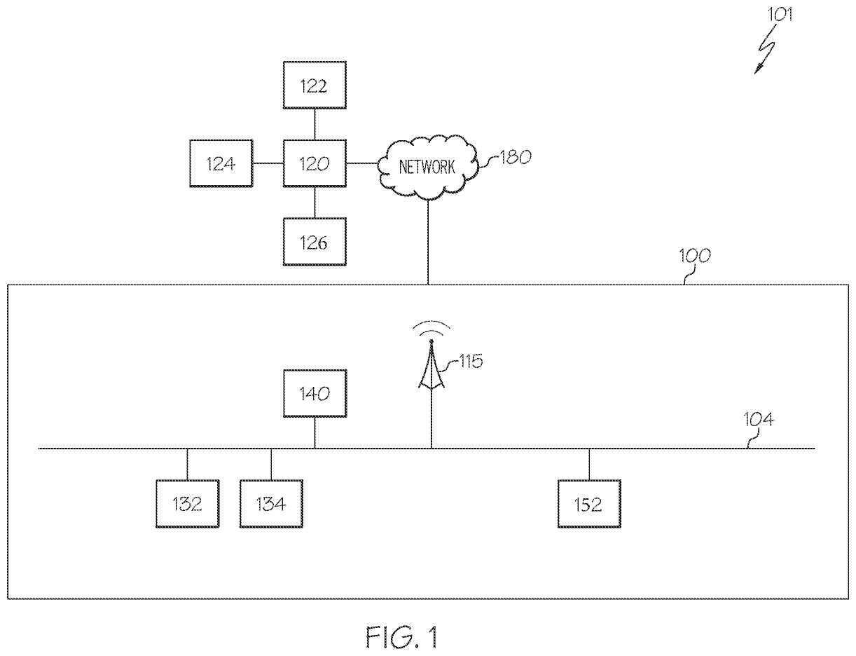

Referring now to FIG. 1, a system 101 for providing targeted recommendations to a user is schematically depicted. The system 101 may include a greater or fewer number of components than depicted without departing from the scope of the present disclosure. The system 101, in embodiments, includes a communication path 104, one or more processors 132, one or more memory modules 134, and network interface hardware 115. In various embodiments, one or more portions of the system 101 may be incorporated into a vehicle 100. For example, the vehicle 100 may include one or more of the one or more processors 132, the network interface hardware 115, and/or the one or more memory modules 134. However, in other embodiments, one or more portions of the system 101 may be outside of the vehicle 100, such as at one or more remote servers 120. Accordingly, in embodiments, the system 101 may further include one or more remote servers 120 and a network 180. In various embodiments, the system 101 may further include one or more user interface devices 140, one or more vehicle sensors 152, etc.

It is noted that while the vehicle 100 is generally disclosed as an automobile, the vehicle 100 may be any passenger vehicle such as, for example, a terrestrial, aquatic, and/or airborne vehicle. In some embodiments, the vehicle 100 may be an autonomous vehicle or a partially autonomous vehicle. When referring to autonomous or partially autonomous vehicles, it is meant to refer to vehicles having at least one drive mode wherein a human operator is not necessary to guide the vehicle 100.

The communication path 104 provides data interconnectivity between various modules disposed within the vehicle 100 and/or system 101. Specifically, each of the modules can operate as a node that may send and/or receive data. In some embodiments, the communication path 104 includes a conductive material that permits the transmission of electrical data signals to processors, memories, sensors, and actuators throughout the vehicle 100 or system 101. In another embodiment, the communication path 104 can be a bus, such as, for example, a LIN bus, a CAN bus, a VAN bus, and the like. In further embodiments, the communication path 104 may be wireless and/or an optical waveguide. Components that are communicatively coupled may include components capable of exchanging data signals with one another such as, for example, electrical signals via conductive medium, electromagnetic signals via air, optical signals via optical waveguides, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The one or more processors 132 may be any device capable of executing machine-readable instructions stored on a non-transitory computer-readable medium, such as the one or more memory modules 134. Accordingly, the one or more processors 132 may include an electric controller, an integrated circuit, a microchip, a computer, or any other computing device. The one or more processors 132 may be communicatively coupled to the other components of the vehicle 100 and/or system 101 by the communication path 104. Accordingly, the communication path 104 may communicatively couple any number of components with one another, and allow the components coupled to the communication path 104 to operate in a distributed computing environment. Specifically, each of the components may operate as a node that may send and/or receive data. While the embodiment depicted in FIG. 1 illustrates a single processor, other embodiments may include more than one processor.

The one or more memory modules 134 may be communicatively coupled to the one or more processors 132 over the communication path 104. The one or more memory modules 134 may be configured as volatile and/or nonvolatile memory and, as such, may include random access memory (includes SRAM, DRAM, and/or other types of RAM), flash memory secure digital (SD) memory, registers, compact discs (CD), digital versatile discs (DVD), and/or other types of non-transitory computer-readable mediums. Depending on the particular embodiment, these non-transitory computer-readable mediums may reside within the vehicle 100 and/or external to the vehicle 100, for example at the one or more remote servers 120. The one or more memory modules 134 may be configured to store one or more pieces of logic as described in more detail below. The embodiments described herein may utilize a distributed computing arrangement to perform any portion of the logic described herein. While the embodiment depicted in FIG. 1 illustrates a single memory module, other embodiments may include more than one memory module.

Embodiments of the present disclosure include logic that includes machine-readable instructions and/or an algorithm written in any programming language of any generation (e.g., 1GL, 2GL, 3GL, 4GL, and/or 5GL) such as, machine language that may be directly executed by the one or more processors 132, assembly language, object-oriented programming (OOP), scripting languages, microcode, etc., that may be compiled or assembled into machine-readable instructions and stored on a machine-readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the functionality described herein may be implemented in any conventional computer programming language, as pre-programmed hardware elements, or as a combination of hardware and software components. In particular, logic as provided here, allows the system 101 and/or vehicle 100 to generate recommendations for various vehicle accessories as will be described in greater detail below. In particular, logic as will be describe herein, allows the system 101 and/or vehicle 100 to determine targeted recommendations, advertisements, or the like.

The network interface hardware 115 may be communicatively coupled to the one to more processors 132 over the communication path 104. The network interface hardware 115 may be any device capable of transmitting and/or receiving data via a network 180. Accordingly, network interface hardware 115 can include a communication transceiver for sending and/or receiving any wired or wireless communication. For example, the network interface hardware 115 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 115 includes hardware configured to operate in accordance with the Bluetooth wireless communication protocol. In another embodiment, the network interface hardware 115 may include a Bluetooth send/receive module for sending and receiving Bluetooth communications to/from a network 180.

The network interface hardware 115 allows the one or more processors 132 to communicate for example with a remote server 120, such as any number of remote servers, and/or remote user devices (e.g., mobile devices, laptops, computers, etc.). The network 180 may include one or more computer networks (e.g., a personal area network, a local area network, or a wide area network), cellular networks, satellite networks and/or a global positioning system and combinations thereof. Accordingly, the one or more processors 132, the remote server 120, and/or remote user devices, and/or other components of the system 101 may be communicatively coupled to each other through the network 180 via wires or wireless technologies, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

A remote server 120 may be connected to the network 180 and may include its own processors (such as one or more remote processors 124), memories (such as one or more remote memory modules 126), chipsets, network interface hardware, and the like. For example, the remote server 120 may perform one or more portions of logic execution as described herein to generate recommendations. Accordingly, a portion of the logic may be performed such as at the one or more processors 132 within the vehicle and a portion of the logic may be performed at the remote server 120. Accordingly, the remote server 120 and other components of the system 101 may communicate via the network 180.

In embodiments, the system 101, such as at the remote server 120, is configured to implement a machine-learning model 122. The machine-learning model 122 is a system that can learn from inputs and make predictions or decisions. Machine-learning models 122 are trained using a dataset. In embodiments, the machine-learning model 122 is configured to be trained using data transmitted through the network 180 to the remote server 120 or otherwise stored at the remote server, such as on the remote memory module 126. Data includes, but is not limited to the vehicle data including vehicle performance data, vehicle occupant data, and vehicle owner data. Further, training data may include user interactions with the user interface, including responses to recommendations already made. In some embodiments, the training data may further include data with respect to vehicle accessories already implemented on the vehicle 100 or services already performed on the vehicle 100. As noted above, vehicle accessories may include physical accessories mounted to the vehicle 100, software packages implemented on the vehicle 100, and/or services performed on the vehicle 100. Other information such as market data, vehicle accessory selections by other users, and the like may also be included as training data.

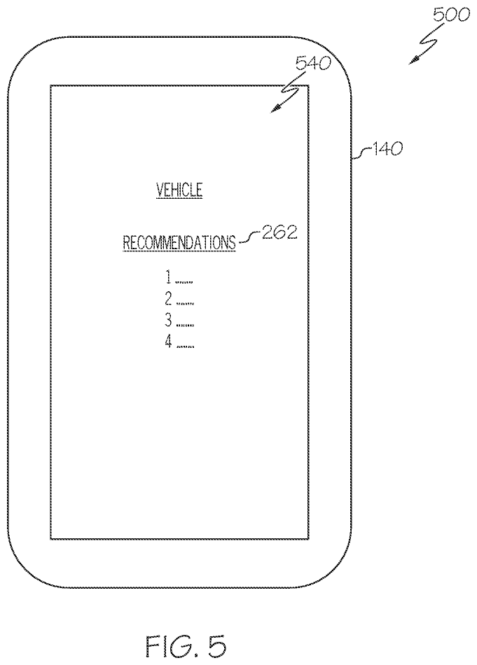

The machine-learning model 122 may be or include supervised learning models, unsupervised learning models, semi-supervised learning models, reinforcement learning models, deep learning models generative models, transfer learning models, neural networks or the like. In embodiments, the remote server 120 is configured to use the machine-learning model 122 to input data and output recommendations 262 (FIG. 5). It should be understood that this process may be completed by any processor, including the one or more processors 132 at the vehicle 100.

The machine-learning model 122 can be one of a variety of models and algorithms. The following list of models is merely an example. The machine-learning model 122 implemented in the present embodiments may be a supervised learning model, an unsupervised learning model, a semi-supervised learning model, a reinforcement learning model, a deep learning model, a generative model, an adversarial network, a variational auto encoder, or the like.

It is noted that while only one remote server 120 is illustrated, in various embodiments there may be multiple remote servers 120 providing various information over the network 180. For example, servers storing user data, such as purchase histories, browser histories, social media profiles, financial data, and the like may also be included and provide data for input into the machine learning model.

Still referring to FIG. 1, the vehicle 100 and/or system 101 may include a user interface device 140. The user interface device 140 may be associated with or implemented as part of the vehicle 100. In other embodiments, the user interface device 140 may be a remote device (e.g., mobile device, laptop, desktop, tablet, etc.). A user interface device 140 associated with the vehicle 100 is a device or technology that can be used in a vehicle 100 to provide various functions and services to the user. In embodiments, these devices can be installed in the vehicle 100, connected to the processor 132 of the vehicle 100 and/or communicate directly or wirelessly via the communication path 104. Some examples of vehicle user devices include, in-vehicle infotainment systems (IVI), heads-up displays (HUD), rear-seat entertainment systems, smartphone integration systems, and/or the like. These devices can be used for a variety of purposes such as navigation, entertainment, communication, safety, and vehicle management. In embodiments, the user interface device 140 may be used to provide vehicle data in addition to providing recommendations to the user. Further, the user interface device 140 may be communicatively coupled to the other components of the system 101 through the network 180, the network interface hardware 115, or the communication path 104.

As noted above, the system 101 and/or vehicle 100 may include one or more vehicle sensors 152 configured to output vehicle data. The vehicle data may include information indicative of accessories installed or implemented on the vehicle. For example, the sensors may output signals indicative of an accessory (e.g., running boards, lighting devices, winch assemblies, hitch assemblies, auxiliary lighting, tow packages, seat covers, mats, carriers, radios, tires, or the like mounted to the vehicle 100). In embodiments, vehicle data may not be provided by the vehicle sensors 152 or only by the vehicle sensors 152. In some embodiments, vehicle data may include information from the one or more memory modules 134 regarding current software packages, recent updates, etc. In some embodiments, the vehicle data may include information related to services performed on the vehicle 100 (e.g., tire rotations/replacement, oil changes, paint, mileage-based standard services, etc.). Such information may be stored in the one or more memory modules 134 and or on a remote server 120, or may be determined via vehicle sensor data.

The one or more vehicle sensors 152 may include, but are not limited to, proximity sensors, microphones or audio sensors, one or more cameras, infrared light emitters and detectors, a global positioning system (GPS), weather sensors, speed sensors, steering wheel sensors, LIDAR and RADAR systems, vehicle APIs, UIs, echo location sensors, vehicle-to-vehicle communication paths, vehicle telematics sensors (e.g., acceleration sensors, braking sensors, steering sensors, yaw sensors, fuel consumption sensors, accident sensors, lane departure sensors, impact sensors, etc.), and the like. These sensors may collect data, such as but not limited to, acceleration data, braking data, steering data, brake usage, lane departures, routes, time, location, fuel consumption, idling, distance traveled, accidents, historical location data, current accessory data, software data, occupant data, and the like.

A proximity sensor may be any device or combination of components capable of outputting a signal indicative of the presence or absence of an object within or near the vehicle 100. The proximity sensor may also be a sensor capable of determining a range or distance to an object, for example the distance from the vehicle and another vehicle that is traveling in front of the vehicle 100. In some embodiments, one or more proximity sensors may be configured to enable an around view monitoring system for the vehicle 100. Output from proximity sensors may provide information relevant to accessories mounted to a vehicle 100 or services performed on the vehicle 100. For example, proximity output, such as in addition to other outputs, such as image data, may allow a system to determine installation an accessory or performance of a service on the vehicle 100.

A microphone or audio sensor may be any device capable of transforming a mechanical vibration associated with sound into an electrical signal indicative of the sound. In embodiments, the microphone may be used to monitor sound levels for purposes such as determining the existence of traffic, infotainment settings, etc. In other embodiments, the microphone may be used to monitor words spoken within the vehicle 100 that may indicate desires of a driver or occupants of the vehicle 100.

The one or more cameras may enable a variety of different monitoring, detection, control, and/or warning systems within a vehicle 100. The one or more cameras may be any device having an array of sensing devices (e.g., a CCD array or active pixel sensors) capable of detecting radiation in an ultraviolet wavelength band, a visible light wavelength band, or an infrared wavelength band. For example, using the output of the one or more cameras, object recognition may be performed on the image data, such as via the one or more processors 132 or at the remote server 120 to determine and identify accessories mounted to and/or services performed on the vehicle 100.

The infrared sensor may be an electronic device that detect infrared radiation. The infrared sensor may detect a change in temperature, or detect temperature differences between an object and its surroundings. The infrared sensor can be used to detect temperatures and movement within the vehicle 100. For example, such information may provide input as to a user or occupants HVAC settings, seat settings, or the like.

The global positioning system, or GPS, may be coupled to the communication path 104 and communicatively coupled to the processor 132 of the vehicle 100. The GPS is capable of generating location information indicative of a location of the vehicle 100 by receiving one or more GPS signals from one or more GPS satellites. The GPS signal communicated to the processor 132 via the communication path 104 may include location information comprising a National Marine Electronics Association (NMEA) message, a latitude and longitude data set, a street address, a name of a known location based on a location database, or the like. Additionally, the GPS may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. Using location information, the system 101 may receive information relevant to places or locations driven/visited, which may provide input for accessories, software packages, services, or the like which may be desirable by a user.

Weather sensors may be temperature sensors, precipitation gauges, wind meters, UV light sensors, or the like. The weather sensors may be coupled to the communication path 104 and communicatively coupled to the processor 132. The weather sensors may be any device capable of outputting a signal indicative of a weather condition such as a temperature level, the presence or an amount of precipitation, the direction and/or speed of the wind, the presence and/or intensity of sunlight or the like. Weather sensors may provide information which may be relevant to driving conditions of the vehicle 100. For example, information relevant snowy conditions, slippery conditions, high wind conditions, or the like may provide input for determining accessories, software packages, services, or the like which may be desirable by a user.

A vehicle speed sensor may be any sensor or system of sensors for generating a signal indicative of vehicle speed. For example, without limitation, a vehicle speed sensor may be a tachometer that is capable of generating a signal indicative of a rotation speed of a shaft of the vehicle engine or a drive shaft. In some embodiments, the vehicle speed sensor comprises an opto-isolator slotted disk sensor, a Hall Effect sensor, a Doppler radar, or the like. The vehicle speed sensor may be provided so that the processor 132 may determine when the vehicle 100 accelerates, maintains a constant speed, slows down or is comes to a stop. Again, such driving behaviors may provide input for determining accessories, software packages, services, or the like which may be desirable by a user.

A steering wheel sensor system may comprise a plurality of sensors located in the steering wheel for determining a driver grip on the steering wheel, the degree of rotation applied to the steering wheel or the forces applied in turning or maintaining the steering wheel. The steering wheel sensor system may provide signals to the one or more processors 132 indicative of the location and number of hands on the steering wheel, the strength of the grip on the steering wheel, or changes in position of one or more hands on the steering wheel. The steering wheel sensor system, for example, without limitation, may include pressure sensors, inductive sensors, optical sensors, or the like. In addition to detecting the location, number, grip, and change in position of one or more hands on the steering wheel, the steering wheel sensor system may also include one or more sensors indicating the rotational angle of the steering wheel and provide corresponding signals to the processor 132. Such information may be relevant to driving behaviors of the owner or occupant.

A LIDAR system or light detection and ranging is a system and method of using pulsed laser light to measure distances from the LIDAR system to objects that reflect the pulsed laser light. In embodiments, the LIDAR systems can be used by vehicles to provide detailed 3D spatial information for the identification of objects near a vehicle 100, as well as the use of such information in the service of systems for vehicular mapping, navigation and autonomous operations, especially when used in conjunction with geo-referencing devices such as GPS or a gyroscope-based inertial navigation unit or related dead-reckoning system. Similar to the sensors above, such output may be useful in determining specific vehicle situations which may be useful for determining accessories, software packages, services, or the like which may be desirable by a user

The vehicle UI or user interface device 140 allows the user of the vehicle 100 to interact and control the vehicle. In embodiments, the vehicle UI can be used to provide information regarding the occupants of the vehicle 100 and generate vehicle occupant data and vehicle owner data. This information may include, but is not limited to a user's preferences for vehicle settings, for example stereo settings, lighting levels, seat settings, and outside communications, personal information, for example, personal identifying information and demographic information, location data, usage data, or the like.

The vehicle API or application programming interface is a set or protocols, routines and tools that allow software applications to communicate with the vehicle 100 processor 132. The vehicle API provides usage data from the vehicle including location data, diagnostic data, maintenance data, trip data, and other information related to the performance and status of the vehicle 100.

The echolocation sensor, or an ultrasonic sensor, is a device that uses sound waves to detect objects and measure their distance. The echolocation sensor works by emitting high-frequency sound waves and then listening for their echoes as they bounce back off of objects and may be used to detect obstacles, measure distances, and aid in navigation of the vehicle 100.

Other data sources are contemplated and possible, such as vehicle telematics data.

As noted above, the vehicle data may include vehicle performance data, vehicle occupant data, and/or vehicle owner data. As noted above, the one or more vehicle sensors 152 may supply the data related to the vehicle performance data, vehicle occupant data, and vehicle owner data. The vehicle data may reside local to in the one or more memory modules 134 and/or remote in the one or more remote servers 120 (e.g., driving data, environment information, known conditions, driver information and/or salient portions of the environment) for access by the system 101 and/or other components. The vehicle data in the one or more memory modules 134 stores, for example, vehicle performance data that may include information from one or more vehicle sensors 152 recorded during past driving events, as described below. Further, the vehicle data may include vehicle occupant data related to an occupant of the vehicles inputs and an occupant's interactions with user interfaces (UI) of the vehicle 100, of which may also include data gathered from vehicle sensors 152. The vehicle data may additionally include vehicle owner data, including demographic information on the owner of the vehicle 100.

Vehicle performance data is output by the one or more vehicle sensors 152 as described above, for example the proximity sensors, one or more cameras, a global positioning GPS, weather sensors, speed sensors, steering wheel sensors, LIDAR and RADAR systems, vehicle APIs, vehicle-to-vehicle communication paths, and vehicle telematics sensors. The vehicle performance data may relate to how well the vehicle 100 performs, including on speed, acceleration, braking, fuel efficiency, power, torque, handling, suspension and other feedback useful to determining the performance of the vehicle 100. Based upon vehicle performance data, the system 101 may generate recommendations of accessories related to the improvement of vehicle performance, accessories related to an association with drivers who share driving characteristics based on the vehicle performance data (e.g. fast drivers, high fuel efficiency, hard driving, ext.), and more.

Vehicle occupant data includes data related to the people who are riding in the vehicle 100 at a particular time and may be generated by vehicle sensors 152. For example, vehicle sensors 152 like the cameras, audio sensors, ultrasonic sensors, or eco location mapping can help determine vehicle occupant data related to the number of occupants, physical characteristics, interactions with the vehicle 100 (e.g. conversations using vehicle microphone, interactions with user interface, interactions from connected user devices, etc.), vehicle settings (e.g. seat, air conditioning, music, sound system settings, ambient colors, etc.) and the like. Further, the vehicle occupant data may be data stored in the one or more memory modules 134 as a user profile. Based upon vehicle occupant data, the system 101 may generate recommendations of accessories, services, or software related to an occupant of the vehicle 100, and the occupant's interactions with the vehicle 100.

The vehicle owner data related to the ownership of the vehicle 100 may be generated from vehicle sensors 152, generated from data stored in the one or more memory modules 134, generated from a user interface device 140 or generated from user inputs. The vehicle sensors, 152, for example, the microphones or audio sensors, the one or more cameras, a global positioning GPS, vehicle APIs, UIs, and vehicle-to-vehicle communication paths may generate information related to the ownership of the vehicle (e.g. place of work, home, demographic information, etc.). Vehicle owner data related to ownership of a vehicle 100 may include the vehicle identification number (VIN), make and model, year, color, license plate number, registration information, and insurance information. In embodiments, it may also include information about the current owner, such as their name, address, and contact information. In some cases, it may also include information about previous owners and any accidents or damage the vehicle has been involved in.

In embodiments, the vehicle data, including the vehicle performance data, the vehicle occupant data, and the vehicle owner data, may be gathered through information available as market data or any other source of data connected through the network 180 or communication path 104. Referring still to FIG. 1, market data may be found and stored using the remote server 120. The market data includes vehicle information, accessory information, services information, owner information, pricing information, images, reviews, ratings, inventory, location, vehicle history reports, and the like. Further, the market data may include data on vehicle insurance, warranty plans, financing and more. The market data may be supplied as an input to the machine-learning model 122 through the network 180.

Various accessories may be mounted to or coupled to the communication path 104 of the vehicle 100. Information on the accessories may be gathered using the vehicle sensors 152, for example, proximity sensors, microphones or audio sensors, one or more cameras, infrared light emitters and detectors, vehicle APIs, UIs, echo location sensors and vehicle telematics sensors may ascertain changes in the vehicle and determine current accessories mounted to the vehicle 100. In embodiments the accessories may be in communication with the one or more processors 132 of the vehicle 100 through plug in connections, wireless connections, RFID readers or any other system that allows the accessory to communicate via the communication path 104 with the one or more processors 132. Examples of accessories may be running boards, lighting devices, winch assemblies, hitch assemblies, auxiliary lighting, tow packages, seat covers, mats, carriers, radios, tires, or any other item that may customize, upgrade, or otherwise attach to or connect with the vehicle 100.

In some embodiments, the system 101 may determine software packages stored in the one or more memory modules 134 of the vehicle 100. The software packages may cause the vehicle to drive or respond using preset settings to a variety of thresholds (e.g. torque setting on hills). In embodiments, the software includes drive modes of a vehicle. In embodiments, the drive modes include snow mode, sport mode, rock mode, sand mode, mountain mode or the like. It should be understood that the software may be any software to improve the performance of the vehicle 100. As described below, the system 101 may generate a recommendation for a software package based on the vehicle data and a determination of software packages stored in the one or more memory modules 134.

In some embodiments, the one or more memory modules 134 of the vehicle may store information related to services completed on the vehicle 100. Examples of services may include routine maintenance, detailing, diagnostic services, battery replacements, body work and the like. Services stored on the memory module (either locally or remotely) may also include lease agreements, financing, rental agreements or other financial based service. As will be describe below, such information may be provided as data and/or used to filter or edit potential recommendation lists.

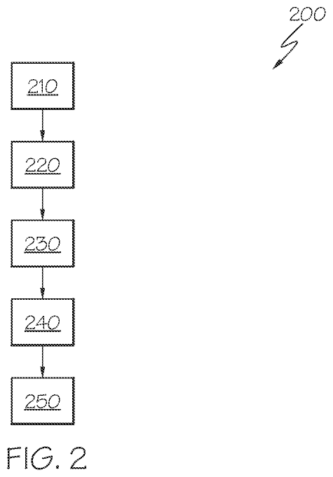

Now referring to FIG. 2, a flowchart 200 of an example method for a providing a recommendation 262 (FIG. 5) for a vehicle accessory or service is depicted. As described above, the method may be carried out by a processor 132 of a vehicle 100, a remote server 120, or a combination of both. The flowchart 200 depicted in FIG. 2 is a representation of a machine-readable instruction set stored in the one or more memory modules 134, or remote memory module 126 and executed by the one or more processors 132 or a remote server 120. The process of the flowchart 200 in FIG. 2 may be executed at various times and in response to inputs or other signals from a user interface device 140 communicatively coupled to the processor 132 or the remote server 120. In other embodiments, the process of the flowchart 200 may be executed as directed by a remote source or otherwise automatically without the input of a user. For example, recommendations may be generated periodically (e.g., yearly, quarterly, monthly, weekly, daily, etc.), automatically as new accessories or services become available, or the like.

In particular, at block 210, the logic executed by the one or more processors 132 cause the one or more processors to generate or receive data regarding one or more of vehicle performance data, vehicle occupant data, or vehicle owner data as described above. As noted above, sources of data may include the one or more vehicle sensors 152 (e.g., data with respect to vehicle operation (e.g., speed, acceleration, braking, turning etc.), data with respect to vehicle settings (e.g., infotainment settings, HVAC settings, navigation settings, etc.), data with respect to vehicle occupants (e.g., conversation data (such as received via a microphone), number of occupants, age of occupants (e.g., such as determined via image data from in-vehicle cameras and object recognition, etc.). Vehicle owner data may be entered via the user interface device or may be stored on a remote server, such data may include user demographic information (e.g., age, gender, ethnicity, marital status etc.), vehicle type information (e.g., sport car, sport utility vehicle, utility vehicle, etc.). In embodiments, vehicle owner data includes information from social media accounts, browsing histories, financial information, or the like. Other sources of vehicle data are contemplated and possible. However, in embodiments, at least a portion of the data may be generated by the one or more vehicle sensors 152, which may provide real-time or near real-time updates to vehicle operation and/or vehicle occupants.

At block 220, the one or more processors 132 generate a first listing of a plurality of recommendations based on the received vehicle data. For example, the first listing of recommendations may include all potential upgrades (e.g., servicers, offers, accessories (either physical or software)), available to the particular vehicle and based on the information provided by the vehicle data. For example, data related to vehicle operation (e.g., driving behavior, infotainment settings, navigation settings, vehicle locations or destinations, HVAC settings, etc.), vehicle occupant data (e.g., conversation information (e.g. keywords or phrases uttered by a vehicle occupant which may be indicative of desired upgrades or services), number of occupants, age of occupants, etc.), and/or vehicle owner data (e.g., owner demographic information, vehicle type information, social media accounts, browsing histories, financial information, etc.) may all provide information as to potential desired services or upgrades. In embodiments, the plurality of recommendations comprises one of a vehicle upgrade, vehicle service, or vehicle equipment.

To generate the first listing of recommendations, the vehicle data, may be sent from the vehicle 100, such as via the network interface hardware, over the network 180 to the remote server for processing. By processing the vehicle data at the remote server, as opposed to at the vehicle 100, processing power at the vehicle 100 can be reduced or conserved for other vehicle functions. However, in other embodiments, processing of the vehicle data may occur at the vehicle. In any case, using the vehicle data, the system 101 generates the first listing of recommendations. In embodiments, it is noted that the system 101 may implement the machine-learning model 122, which may include trained models trained on data related to other users and their vehicle data and accessory/service selection history. Accordingly, the machine-learning model 122 when executed may generate the first listing of recommendations.

At block 230, the system 101 may determine with the one or more vehicle sensors 152, current accessories mounted to the vehicle, current software stored in the one or more memory modules 134, or current services performed on the vehicle. For example, the one or more vehicle sensors 152 may output indications of services already performed or accessories already implemented on the vehicle 100. In one example, vehicle cameras may capture image data of various portions of the vehicle 100. The image data may be processed such as via object recognition to determine accessories installed on or within the vehicle. In other embodiments, accessories may communicate or download software to the vehicle 100, such that the one or more processors 132 or the vehicle 100 may determine accessories coupled to the vehicle 100 such as via a plug-in connection, wireless connection (e.g., Bluetooth), or RFID communication. In embodiments, the one or more vehicle sensors 152 may be able to detect recent services performed on the vehicle 100 such as tire rotation, oil changes, or the like. The one or more processors 132 may communicate this information over the network 180 to the remote server 120. The remote server 120 may then modify the first listing of the plurality of recommendations at block 240 to provide a tailored listing of recommendations based on the current accessories mounted to the vehicle 100, current software active on the vehicle 100 and/or the current services performed on the vehicle 100. That is, the listing may be reduced based on the accessories or services already performed. In some embodiments, the accessories or services already performed may be grayed out, in the tailored listing, for example.

At block 240, the system 101, such as at the remote server 120, may generate a communication including one or more recommendations from the tailored listing of the plurality of recommendations. At block 250, the communication may then be sent and/or displayed on the user interface device 140 associated with the vehicle 100. In some embodiments, the communication may be sent to a personal user device (e.g., mobile device, computer, etc.). The user interface device 140, as described above, may be a vehicle head unit, or a mobile device that is associated with the vehicle. For example, the recommendation may be displayed through an application, webpage, or other communication, as described in further detail below and as seen in FIG. 5.

In some embodiments, the first listing of recommendations may be communicated to the one or more processors 132 of the vehicle 100, and then the vehicle 100 may process the first listing of recommendations based on the current accessories mounted to the vehicle 100, current software active on the vehicle 100 or current services performed on the vehicle 100 to create the tailored listing of the plurality of recommendations. In such embodiments, processing power or costs may therefore be shared between the vehicle 100 and the remote server 120. However, it is noted by tailoring the listing of recommendations at the remote server 120, bandwidth and network speed impacts may be reduced, as the resulting communications may be reduced.

As a non-limiting example, vehicle data may indicate that a user often user drives through mountains in winter. Based on this information, a first listing of recommendations may include all software and/or accessories which may be relevant to driving through mountains in winter. For example, accessories useful for traveling through mountains in winter may be snow tires, tires chains, software controlled driving modes optimized for driving over slippery surfaces, thermal sleeping bags, back-up battery chargers, generators, or the like. Based on the one or more sensors 152, the one or more processors 132 further determine the vehicle 100 already has snow tires equipped. The system 101 may then modify the list of recommendations to remove or gray out snow tires and, potentially, tire chains, from the listing of recommendations while leaving in the tailored listing of recommendations, which may be selectable by a user.

As another example, the vehicle data, may indicate that the vehicle 100 is driven aggressively based on acceleration data and brake data and other data produced by vehicle sensors 152. Additionally, the vehicle data may indicate the owner searched via the user interface device 140 for lake activities and/or the user lives close to a lake based on GPS. Based on this information, a first listing of a plurality of recommendations may include all software and/or accessories that may be relevant for a water sports, including trailers for boats, carriers for camping supplies, and/or an off road drive mode. Based on the one or more vehicle sensors 152, the one or more processors 132 further determine the vehicle 100 already includes a top rack for fishing equipment installed. The system 101 may then modify the first listing of the plurality of recommendations to remove or gray out the carriers while leaving in the tailored listing of recommendations, which may be selectable by a user.

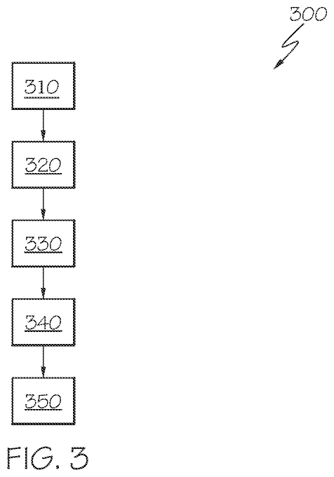

Now referring to FIG. 3, a flowchart 300 of an example method for a recommendation of a software package is depicted. As described above, the method may be carried out by a processor 132 of the vehicle 100, the remote server 120, or a combination of both. The flowchart 300 depicted in FIG. 3 is a representation of a machine-readable instruction set stored in the one or more memory module s134, or remote memory module 126 and executed by the processor 132 or a remote server 120. The process of the flowchart 300 in FIG. 3 may be executed at various times and in response to inputs or other signals from a user interface device 140 communicatively coupled to the processor 132 or the remote server 120. In other embodiments, the process of the flowchart 300 may be executed as directed by a remote source or otherwise automatically without the input of a user. For example, recommendations may be generated periodically (e.g., yearly, quarterly, monthly, weekly, daily, etc.), automatically as new accessories or services become available, or the like.

In particular, at block 310, the logic executed by the one or more processors 132 (or one or more remote processors 124) cause the one or more processors 132 (or one or more remote processors 124) to generate or receive data regarding software packages stored in the one or more memory modules 134. Other sources of data regarding software packages are contemplated and possible. In embodiments, sources of data may include the one or more vehicle sensors 152, data with respect to vehicle settings, and data related to vehicle operation. In embodiments, the data regarding software packages includes software packages that are active on the vehicle 100 and software packages that are not active on the vehicle 100. For example, software packages may be installed on the vehicle 100 but not active on the vehicle until activated by a user through a user interface device 140. Further, the remote server 120 may generate data on software packages available in the marketplace for the vehicle 100. In embodiments, software packages comprise an available drive mode package configured to enable a drive mode of the vehicle. In other embodiments, software packaged may include other enhancements to the vehicle, including improvements to the user interface, displays, settings, or other cosmetic features of the vehicle.

At block 320, the one or more processors 132 determined whether the recommended software package in the first listing of a plurality of recommendations is currently active on the vehicle 100. In embodiments, this may be evident by logic stored in the one or more memory modules 134 and executed by the one or more processors 132. The one or more processors 132 may communicate this information over the network 180 to the remote server 120. However, in embodiments, the one or more vehicle sensors 152 may be able to detect current software active on the vehicle 100 from data related to the vehicle operation.

At block 330, the remote server 120 may modify the first listing of the plurality of recommendations generated above to provide a tailored listing of recommendations based on the current software active on the vehicle 100 and/or the software available to the vehicle 100. At block 340, the system 101, such as at the remote server 120, may generate a communication including one or more recommendations from the tailored listing of the plurality of recommendations. At block 350, the communication may then be sent and/or displayed on the user interface device associated with the vehicle. In some embodiments, the communication may be sent to a personal user device (e.g., mobile device, computer, etc.).

As a non-limiting example, vehicle data indicates a user drives consciously, always navigates the vehicle 100 using the most eco-friendly routes, and decorates the vehicle with environmentally friendly cause accessories. The first listing of the plurality of recommendations may include an eco-drive mode, water bottles, and camping gear. Upon a determination by the one or more processors 132 that the user has eco drive mode active on the vehicle 100, the system 101 may then modify the list of recommendation to remove the eco drive mode while leaving a tailored modified listing that may highlight camping gear.

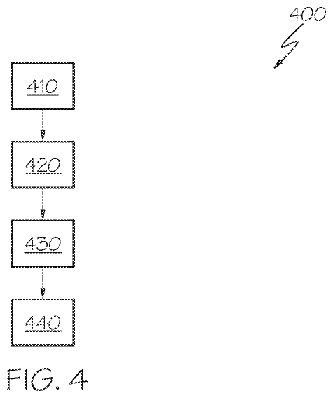

In some embodiments, the methods described above may further include ranking of the recommendations based on vehicle data. Such additional steps are illustrated in FIG. 4, wherein a flowchart 400 of an example method for a providing a ranked listing of the plurality or recommendations based on a determined rank of desirability is depicted. As described above, the method may be carried out by a processor 132 of a vehicle 100, a remote server 120, or a combination of both. The flowchart 400 depicted in FIG. 4 is a representation of a machine-readable instruction set stored in the one or more memory modules 134, or remote memory module 126 and executed by the processor 132 or a remote server 120. The process of the flowchart 400 in FIG. 4 may be executed at various times and in response to inputs or other signals from a user interface device 140 communicatively coupled to the processor 132 or the remote server 120. In other embodiments, the process of the flowchart 400 may be executed as directed by a remote source or otherwise automatically without the input of a user.

At block 410, the logic executed by the one or more processors 132 cause the one or more processors 132 to generate or receive data regarding the accessories, software, and/or services on the modified list of recommendations, as described above. Data regarding the accessories, software, and/or services may be sourced through the network 180 from market data, or any other source communicatively coupled to the one or more processors 132, including the remote server 120.

At block 420, the one or more processors 132 may generate a rank of desirability or the recommendations. The rank of desirability of the recommendations may be determined using the machine-learning model, which may determine desirability based on similar user data and implemented accessories, software, and services. In such embodiments, the vehicle data, market data, data regarding the accessories, software, and/or services generated at block 410 and any other relevant data as determined in methods above is input into the machine-learning model 122 along with the first listing, for example, to generate a rank of desirability of each recommendation. For example, there may be a strong correlation between users that visit the lake and users that opt for a towing package. There may also be a strong, though less strong correlation between users that visit a lake and have auxiliary lights installed on the vehicle. In such embodiments, the desirability for the towing package may be higher than the desirability for the auxiliary lights. Further, the ranking of desirability of accessories may continuously be updated with the machine-learning model as the user inputs responses through the user interface device 140.

At block 430, the one or more processors 132 and/or the remote server 120 may organize the list of recommendations generated at block 240 based on the determined rank of desirability of accessories, software, and/or services available to the vehicle 100. The one or more processors 132 and/or the remote server 120 then generates a tailored listing of recommendations based on the current accessories mounted to the vehicle, the current software active on the vehicle, the current services performed on the vehicle, and the rank of desirability of the accessories, software, and services as an organized list of a plurality of recommendations that placed a more desired recommendation higher than a less desired recommendation.

At block 440, the system, such as at the remote server, may generate and send a communication including one or more recommendations from the tailored listing of the plurality of recommendations. The communication may be displayed on the user interface device 140 associated with the vehicle. In some embodiments, the communication may be sent to a personal user device (e.g., mobile device, computer, etc.).

In some embodiments, the tailored listing of a plurality recommendations may be further modified or ranked based on user inputs and replies through the user interface device 140. In such an example, the user receives the initial tailored listing of a plurality of recommendations, the user inputs a reply (e.g. buying, not interested, save for later), the system 101 inputs the reply as updated vehicle data into the machine-learning model 122 to generate a new tailored listing of a plurality of recommendations. For example, the system 101 may generate a communication that recommends new seat covers after vehicle data indicates the user has spilled guacamole in the back seat. However, the user denies or ignores the recommendation. Later, the vehicle data shows the user has spilled a milkshake. The machine-learning model 122, updated with the user input, now generates a communication including a ranked modified list of recommendations highlighting cleaning products above recommendations regarding seat covers.

Referring now to FIG. 5, examples of a user interface device 140 including a display 540 is illustrated. In the illustrated embodiment, a communication 500 of the tailored list of recommendations is depicted on the display. FIG. 5 shows a display of the vehicle 100 and the communication 500 of the tailored list of recommendations as generated above. In embodiments, this information may be displayed to a user of a vehicle 100 to interact with, including ordering the accessory, software, or service, ranking the accessory, software, or service, reviewing accessories, software, or service, and denying the accessory, software, or service. In embodiments, these interactions may be saved in the one or more memory modules 134 as vehicle data or owner data. Additionally, these interactions may be saved in the remote server 120 and further used in training the machine-learning model 122. For example, input by the user may communicated to the machine-learning model 122 and used to improve or retrain the model to provide better more targeted recommendations.

It should now be understood that embodiments described herein are directed to systems, methods, and vehicles for generating and providing recommendations for vehicle accessories (e.g., physical accessories, software updates, services, financial options, etc.) through a vehicle head unit or a user interface device. The system may receive vehicle data, and generate a first listing of a plurality of recommendations based on the vehicle data. The system may further determine current accessories or services performed on the vehicle, and modify the first listing of the plurality of recommendations to provide a tailored listing of the plurality of recommendations based on a determination of current accessories mounted to the vehicle or current services performed on the vehicle. Based on the listing, the system may further generate a communication including the tailored listing of the plurality of recommendations and send the user the communication including one or more recommendations. That is, the vehicle may provide improved display of recommendations to a user by tailoring the listing of available accessories based on data collected by one or more vehicle sensors. Moreover, such tailoring of recommendation lists may provide reduced network communication traffic and bandwidth by providing more targeted or focused recommendations as opposed to larger general listings of available accessories. Moreover, as recommendations may be more targeted to a user's specific needs processing power or memory needs may be reduced.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for generating recommendations with respect to a vehicle comprising:
one or more processors;
network interface hardware communicatively coupled to the one or more processors;
one or more memory modules communicatively coupled to the one or more processors that store machine-readable instructions that when executed by the one or more processors, cause the system to:
receive vehicle data related to one or more of vehicle performance data, vehicle occupant data, or vehicle owner data, wherein at least a portion of the vehicle data is generated by one or more vehicle sensors mounted to the vehicle;
generate a first listing of a plurality of recommendations based on the vehicle data;
determine with the one or more vehicle sensors, current accessories mounted to vehicle or current services performed on the vehicle;
modify the first listing of the plurality of recommendations to provide a tailored listing of the plurality of recommendations based on the current accessories mounted to the vehicle or the current services performed on the vehicle;
generate a communication with the one or more processors including one or more recommendations from the tailored listing of the plurality of recommendations; and
send the communication to a user interface device associated with the vehicle.

2. The system of claim 1, wherein the machine-readable instructions further causes the system to;
generate a listing of software packages available to the vehicle;
determine whether one or more of a plurality of software packages are active on the vehicle; and
generate one or more software package recommendations based on the first listing of the plurality of recommendations, the listing of software packages, and the determination of active software packages on the vehicle, wherein
the communication includes the one or more software package recommendations.

3. The system of claim 2, wherein the software packages comprise an available drive mode package configured to enable a drive mode of the vehicle.

4. The system of claim 1, wherein the vehicle sensors include at least one of a GPS, a predictive maintenance API, one or more cameras, one or more ultrasonic sensors, one or more audio sensors, or an echo location mapping.

5. The system of claim 1, wherein the one or more processors are communicatively coupled to one or more of the current accessories such that the current accessories are determined via communication with the one or more processors.

6. The system of claim 5, wherein the one or more of the current accessories are communicatively coupled to the one or more processors through a plug-in connection, wireless connection, or an RFID communication.

7. The system of claim 1, wherein the plurality of recommendations comprises one of a vehicle upgrade, vehicle service, or vehicle equipment.

8. The system of claim 1, wherein the machine-readable instructions further causes the system to:
determine a rank of desirability of accessories based on the vehicle data; and
organize a ranked listing of the plurality of recommendations based on the determined rank of desirability, wherein
the communication includes the ranked listing of the plurality of recommendations.

9. A method of determining recommendations with respect to a vehicle comprising:
receiving vehicle data related to one or more of vehicle performance data, vehicle occupant data, or vehicle owner data, wherein at least a portion of the data is generated by one or more vehicle sensors mounted to the vehicle;
generating, with one or more processors communicatively coupled to the one or more vehicle sensors, a first listing of a plurality of recommendations based on the vehicle data;
determining with the one or more vehicle sensors, current accessories mounted to vehicle or current services performed on the vehicle;
modifying the first listing of the plurality of recommendations to provide a tailored listing of the plurality of recommendations based on the determination of the current accessories mounted to the vehicle or the current services performed on the vehicle;
generating a communication with the one or more processors including one or more recommendations from the tailored listing of the plurality of recommendations; and
sending the communication to a user interface device associated with the vehicle.

10. The method of claim 9, further comprising;
generating a listing of software packages available to the vehicle;
determining whether one or more of a plurality of software packages are active on the vehicle; and
generating, with the one or more processors, one or more software package recommendations based on the first listing of the plurality of recommendations, the listing of software packages, and the determination of active software packages on the vehicle wherein
the communication includes the one or more software package recommendations.

11. The method of claim 10, wherein the software packages comprise an available drive mode package configured to enable a drive mode of the vehicle.

12. The method of claim 9, wherein the vehicle sensors include at least one of a GPS, a predictive maintenance API, one or more cameras, one or more ultrasonic sensors, one or more audio sensors, or an echo location mapping.

13. The method of claim 9, wherein the one or more processors are communicatively coupled to one or more of the current accessories such that the current accessories are determined via communication with the one or more processors.

14. The method of claim 13, wherein the one or more of the current accessories are communicatively coupled to the one or more processors through a plug-in connection, wireless connection, or an RFID communication.

15. The method of claim 9, wherein the plurality of recommendations comprises one of a vehicle upgrade, vehicle service, or vehicle equipment.

16. The method of claim 9, further comprising:
determining, with the one or more processors, a rank of desirability of accessories based on the vehicle data; and
organizing a ranked listing of the plurality of recommendations based on the determined rank of desirability, wherein
the communication includes the ranked listing of the plurality of recommendations.

17. A vehicle, comprising;
one or more processors;
one or more vehicle sensors mounted to the vehicle;
one or more user interface devices communicatively coupled to the one or more processors;
network interface hardware communicatively coupled to the one or more processors;
one or more memory modules communicatively coupled to the one or more processors that store machine-readable instructions that when executed by the one or more processors, cause the vehicle to:
communicate vehicle data related to one or more of vehicle performance data, vehicle occupant data, or vehicle owner data to a remote server, wherein at least a portion of the data is generated by the one or more vehicle sensors mounted to the vehicle;
determine with the one or more vehicle sensors, current accessories mounted to vehicle or current services performed on the vehicle;
communicate the current accessories mounted to vehicle or the current services performed on the vehicle to the remove server;
receive a communication with a recommendation from a tailored listing of a plurality of recommendations based on a listing of a plurality of recommendations based on the vehicle data and the determination of the current accessories mounted to the vehicle or the current services performed on the vehicle from the remote server; and
display the communication to a user interface device associated with the vehicle;
receive a user input from the user interface device selecting a recommendation from the tailored listing of the plurality of recommendations; and
automatically update vehicle software based on the user input.

18. The vehicle of claim 17, wherein the machine-readable instructions executed by the one or more processors causes the vehicle to:
communicate a listing of software packages available to the vehicle and whether the software packages are active on the vehicle to the remote server;
receive a communication with a software recommendation based on the listing of software packages and vehicle data from the remote server; and
display the communication to the user interface device associated with the vehicle.

19. The vehicle of claim 18, wherein the software packages may be an available drive mode package configured to enable a drive mode of the vehicle.

20. The vehicle of claim 17, wherein the vehicle sensors include at least one of a GPS, a predictive maintenance API, one or more cameras, one or more ultrasonic sensors, one or more audio sensors, or an echo location mapping.
